(19) United States
(12) Patent Application Publication
(10) Pub. No.: US 2016/0219067 A1
(43) Pub. Date: Jul. 28, 2016

(54) METHOD OF DETECTING ANOMALIES SUSPECTED OF ATTACK, BASED ON TIME SERIES STATISTICS

(71) Applicant: Korea Internet & Security Agency, Seoul (KR)

(72) Inventors: Young Il HAN, Seoul (KR); Dae Hoon Yoo, Seoul (KR); Hyei Sun Cho, Seoul (KR); Bo Min Choi, Seoul (KR); Nak Hyun Kim, Seoul (KR); Tong Wook Hwang, Seoul (KR); Hong Koo Kang, Seoul (KR); Young Sang Shin, Seoul (KR); Byung Ik Kim, Seoul (KR); Tae Jin Lee, Seoul (KR)

(73) Assignee: Korea Internet & Security Agency, Seoul (KR)

(21) Appl. No.: 14/639,357

(22) Filed: Mar. 5, 2015

(30) Foreign Application Priority Data
Jan. 28, 2015 (KR) 10-2015-0013770

(51) Int. Cl. H04L 29/06

(52) U.S. Cl. CPC H04L 63/1425; H04L 63/1416; H04L 63/1433

(57) ABSTRACT

Disclosed is a method of detecting anomalies suspected of an attack based on time series statistics according to the present invention. The method of detecting anomalies suspected of an attack according to the present invention includes the steps of: collecting log data and traffic data in real-time and extracting at least one piece of preset traffic feature information from the collected log data and traffic data; and training through a time series analysis-based normal traffic training model using the extracted traffic feature information, and detecting abnormal network traffic according to a result of the training.

### CROSS REFERENCE TO RELATED APPLICATION

The present application claims the benefit of Korean Patent Application No. 10-2015-0013770 filed in the Korean Intellectual Property Office on Jan. 28, 2015, the entire contents of which are incorporated herein by reference.

### BACKGROUND OF THE INVENTION

1. Field of the Invention

The present invention relates to a technique of detecting anomalies suspected of an attack, and particularly, to a method of detecting anomalies suspected of an attack based on time series statistics using network feature data.

2. Background of the Related Art

Recently, attacking cases of an Advanced Persistent Threat (APT) type are increasing inside and outside Korea, and damages caused by the attacks tend to increase abruptly, and thus techniques of detecting intrusions from outside have long been studied in various ways.

However, recently, a large number of attacks are progressed without directly revealing the attacks, and since some of these attacks encrypt packets or transmit packets after adjusting the traffic amount to avoid detection, detection of a new attack progressed while making a detour to avoid such existing detection methods is limited with an existing detection system based on rules or signatures.

Recently, attacking cases of a new type, such as a newly found zero-day attack or the like making bad use of weak points of security, are increasing, and as one of techniques for responding to these abruptly increasing unknown new attacks, a technique of training features of normal traffic and determining whether or not newly flowing-in traffic is suspected of an attack attracts interest in the security market. However, it is difficult, by the nature of traffic data, to distinguish normal traffic and abnormal traffic by simply comparing the traffic data.

### SUMMARY OF THE INVENTION

Therefore, the present invention has been made in view of the above problems, and it is an object of the present invention to provide a method of detecting anomalies suspected of an attack, which extracts traffic feature information from network traffic, trains through a time series analysis-based normal traffic training model using the extracted traffic feature information, and detects abnormal network traffic suspected of an attack based on a detection threshold value calculated as a result of the training.

However, the objects of the present invention are not limited to the descriptions mentioned above, and unmentioned other objects may be clearly understood by those skilled in the art from the following descriptions.

To accomplish the above objects, according to one aspect of the present invention, there is provided a method of detecting anomalies suspected of an attack, the method including the steps of: collecting log data and traffic data in real-time and extracting at least one piece of preset traffic feature information from the collected log data and traffic data; and training through a time series analysis-based normal traffic training model using the extracted traffic feature information, and detecting abnormal network traffic according to a result of the training.

Preferably, when the time series analysis-based normal traffic training model is used, the detecting step includes: calculating a detection threshold value of each user based on the extracted feature value of network time series data of each user IP; and detecting the abnormal network traffic based on the calculated detection threshold value of each user.

Preferably, the detecting step includes: extracting an average value and a variance value of the network feature data by a time unit; performing a time series analysis on a past observation value based on the extracted average value of each time unit and estimating a predictive value to be observed in the future based on a result of performing the time series analysis; and calculating threshold values of an upper control limit and a lower control limit based on the estimated predictive value and a standard deviation of the predictive value.

Preferably, the detecting step includes obtaining the predictive value using mathematical expression Zₜ=λxₜ+(1−λ)Zₜ₋₁, 0<λ<1, and here, λ denotes a weighing factor of the predictive value, and x denotes feature information (observation value) extracted in each time zone.

Preferably, the detecting step includes obtaining λ using mathematical expression

$$MSE ( λ ) = \sqrt{\frac{{\sum }_{i = 1}^{n} {( {x}_{i} - {Z}_{i} )}^{2}}{n}} ,$$

and here, λ is adjusted to be determined as a value which can minimize a mean square error (MSE) during a training period.

Preferably, the detecting step includes: determining existence of anomaly in flowing-in normal traffic based on the extracted network feature data and the calculated threshold values; and integrating results of determining existence of anomaly in the normal traffic and detecting intrusion according to a result of the integration.

Preferably, the detecting step includes determining existence of anomaly in the normal traffic using mathematical expression “If(X<LCL or X>UCL), Anomaly”, and here, the LCL denotes a threshold value of a lower control limit, and the UCL denotes a threshold value of an upper control limit.

Preferably, the detecting step includes: assigning a different score according to a preset type of the integrated result, and classifying a grade of threat level of the detection result using an average value of all the scores, in which the grade of threat level is calculated using mathematical expression

$$ThreatLevel = [ ln ( \frac{{\sum }_{i = 1}^{k} {ScoreOfAnomaly}_{i} \times {}_{i}^{l} ω}{k} ) ] .$$

Preferably, the traffic feature information includes at least one of the number of packets per flow, an amount of data per flow, a flow duration time, an average number of packets per unit time, an average amount of data per unit time, and an average amount of data per packet.

According to another aspect of the present invention, there is provided a method of detecting anomalies suspected of an attack, the method comprising the steps of: receiving traffic feature information extracted from log data and traffic data from a data collection device and storing the received traffic feature information; and training through a time series analysis-based normal traffic training model using the stored traffic feature information, and detecting abnormal network traffic according to a result of the training.

Preferably, when the time series analysis-based normal traffic training model is used, the detecting step includes: calculating a detection threshold value of each user based on the extracted feature value of network time series data of each user IP; and detecting the abnormal network traffic based on the calculated detection threshold value of each user.

Preferably, the detecting step includes: extracting an average value and a variance value of the network feature data by a time unit; performing a time series analysis on a past observation value based on the extracted average value of each time unit and estimating a predictive value to be observed in the future based on a result of performing the time series analysis; and calculating threshold values of an upper control limit and a lower control limit based on the estimated predictive value and a standard deviation of the predictive value.

Preferably, the detecting step includes: determining existence of anomaly in flowing-in normal traffic based on the extracted network feature data and the calculated threshold values; and integrating results of determining existence of anomaly in the normal traffic and detecting intrusion according to a result of the integration.

### BRIEF DESCRIPTION OF THE DRAWINGS

FIG. 1 is a view showing a system for detecting anomalies suspected of an attack according to an embodiment of the present invention.

FIG. 2 is a view showing a detailed configuration of a device for detecting a symptom of an attack according to an embodiment of the present invention.

FIG. 3 is a first view for describing an anomaly detecting principle according to an embodiment of the present invention.

FIG. 4 is a view for describing a false alarm filtering concept according to an embodiment of the present invention.

FIG. 5 is a second view for describing an anomaly detecting principle according to an embodiment of the present invention.

FIG. 6 is a view showing a method of detecting anomalies suspected of an attack according to an embodiment of the present invention.

FIG. 7 is a view showing a similarity map of an anomaly detection result according to an embodiment of the present invention.

### DESCRIPTION OF SYMBOLS

100: Data collection device
200: Attack symptom detection device
210: Anomaly detection engine
220: Integrated analysis module
230: Result storage DB
300: Integrated control server

### DETAILED DESCRIPTION OF THE PREFERRED EMBODIMENT

Hereafter, a method of detecting anomalies suspected of an attack based on time series statistics according to an embodiment of the present invention will be described with reference to the accompanying drawings. It will be described in detail focusing on the parts needed to understand the operation and actions according to the present invention.

In addition, in describing the constitutional components of the present invention, like constitutional components may be denoted by different reference numerals according to drawings, and different constitutional components may be denoted by like reference numerals. However, even in this case, it does not mean that corresponding constitutional components have different functions according to embodiments or have like functions in different embodiments, but the function of each constitutional component should be determined based on the descriptions of the constitutional component in a corresponding embodiment.

Particularly, the present invention proposes a new method of extracting traffic feature information from network traffic, training through a time series analysis-based normal traffic training model using the extracted traffic feature information, and detecting abnormal network traffic suspected of an attack based on a detection threshold value of each user calculated as a result of the training.

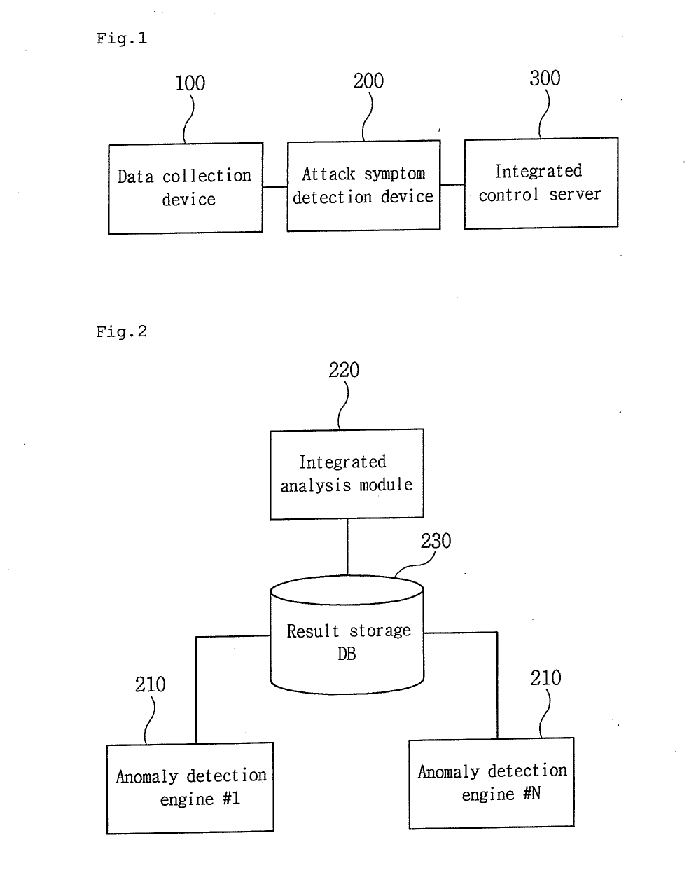

FIG. 1 is a view showing a system for detecting anomalies suspected of an attack according to an embodiment of the present invention.

As shown in FIG. 1, a system for detecting anomalies suspected of an attack according to an embodiment of the present invention may include a data collection device 100, an attack symptom detection device 200, and an integrated control server 300.

The data collection device 100 may collect log data and traffic data in real-time and extract traffic feature information from the collected log data and traffic data.

At this point, the traffic feature information is a data needed for detecting abnormal traffic suspected of an attack and, for example, may be defined as shown in [Table 1].

TABLE 1

| Classification | Item | Description |
|---|---|---|
| Basic traffic | Packets | Number of packets per flow |
| features | Bytes | Amount of data per flow |
| | Duration | Flow duration time (sec) |
| Traffic features | Packets/Duration | Average number of packets |
| of each unit | | per unit time |
| | Bytes/Duration | Average amount of data |
| | | per unit time |
| | Bytes/Packet | Average amount of data |
| | | per packet |
| Others | Normalized data | Normalization of basic |
| | | traffic features and |
| | | traffic feature |
| | | information of each unit |
| | | (LOG, Square, Square |
| | | Root, Reciprocal) |

The attack symptom detection device 200 may be provided with the traffic feature information from the data collection device 100, train through a preset training model using the provided traffic feature information, and detect abnormal network traffic suspected of an attack according to a result of the training.

Network traffic is mostly continuous time series information changing with time. It is important to appropriately design a training model reflecting features of the time series information in order to find abnormal traffic from the network traffic having a feature of changing with time.

Accordingly, the present invention proposes a new method of detecting abnormal traffic suspected of an attack using the traffic feature data changing according to a situation.

The integrated control server 300 may visually provide a result of detecting network anomalies.

FIG. 2 is a view showing a detailed configuration of a device for detecting a symptom of an attack according to an embodiment of the present invention.

As shown in FIG. 2, an attack symptom detection device 200 according to the present invention may include at least one or more anomaly detection engines 210, an integrated analysis module 220, and a result storage DB 230.

The anomaly detection engine 210 trains through a preset training model, such as a time series analysis-based normal traffic training model, a clustering-based normal traffic training model or the like, using the traffic feature information and may detect abnormal network traffic according to a result of the training.

The time series analysis-based normal traffic training model calculates a detection threshold value of each user based on the extracted feature value of network time series data of each user IP and detects abnormal network traffic based on the calculated detection threshold value of each user.

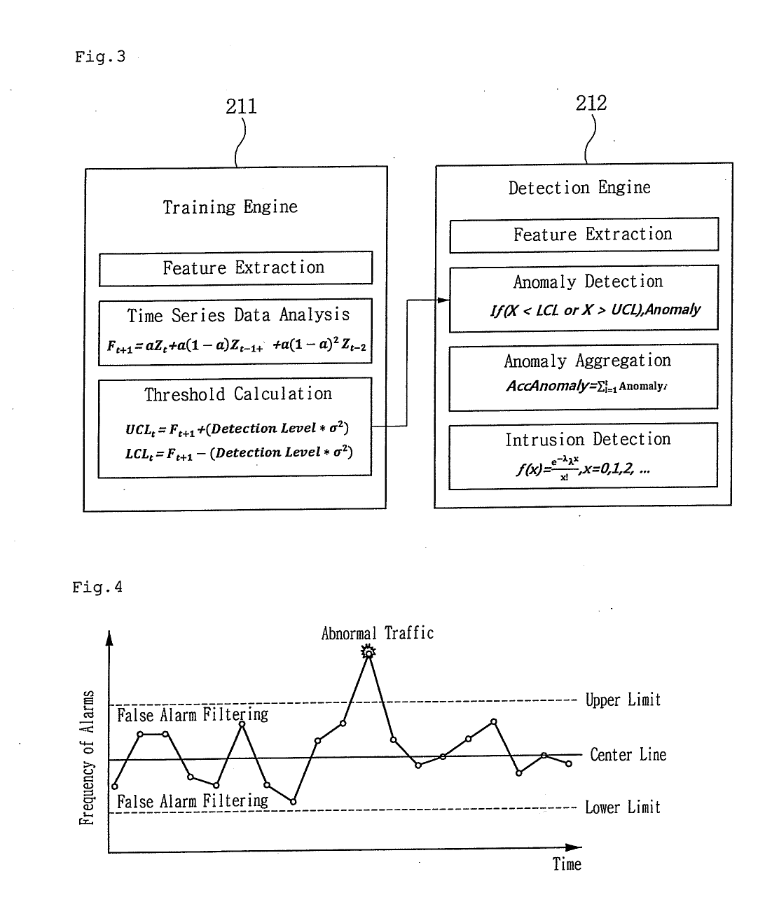

FIG. 3 is a first view for describing an anomaly detecting principle according to an embodiment of the present invention.

Referring to FIG. 3, an anomaly detection engine 210 according to the present invention is configured of a training engine 211 and a detection engine 212 and detects abnormal network traffic.

The training engine 211 calculates an adaptive threshold value based on the time series data observed in a normal state.

For example, in the present invention, a traffic model is subdivided into time zones for each internal user of an organization based on a user IP of the organization, considering that a traffic use pattern of a user in ordinary days is different from a traffic use pattern in holidays and a traffic pattern varies in each time zone. The traffic model subdivided into time zones is largely divided into an ordinary day traffic model and a holiday traffic model, and total forty eight traffic generation time series models are created for each time zone of each ordinary day and holiday. A range of an expected traffic feature data observation value is statistically estimated using changes of the traffic feature values of each of the created time series models observed for four weeks in the same time zone for each traffic model, and a detection threshold value is determined based on the estimated value. As the detection threshold value, forty eight threshold values are calculated for each network feature data of each user based on an internal IP of the organization.

In order to implement a general-purpose model capable of processing a large number of threshold values in a speedy way, an Exponentially Weighted Moving Average (EWMA) method, which is comparatively simple to calculate, is used.

Describing specifically, the training engine 211 may extract an average value and a deviation value of the network feature data by the time unit.

The training engine 211 may perform a time series analysis on a past observation value x based on the extracted average value of each time unit and estimate a predictive value z to be observed in the future based on a result of performing the time series analysis. If a sequence of observation values at a time point t where a correlation does not exist is xₜ, xₜ₋₁, . . . , x₁, a predictive value zₜ which will be observed in the future is expressed as shown in [Mathematical expression 1].

Zₜ=λxₜ+(1−λ)Zₜ₋₁, 0<λ<1 [Mathematical equation 1]

Here, λ denotes a weighing factor of the predictive value, which is a real number less than 1 excluding 0. x denotes feature information, i.e., an observation value, extracted in each time zone, and Z denotes a value calculated by accumulating a value obtained by adding an observation value multiplied by the weighting factor and a previous predictive value multiplied by the weighting value, i.e., denotes a predictive value.

At this point, since the traffic generation pattern is different for each user of each IP, an appropriate weight factor of the predictive value, i.e., a different smoothing constant λ, can be applied to each traffic model of each user to enhance predicting capability.

The present invention proposes an algorithm for correcting a predictive value by re-estimating an appropriate smoothing constant for each user. An appropriate smoothing constant is determined to minimize a mean square error (MSE) during a training period, and such a smoothing constant is expressed as shown in [Mathematical expression 2].

$$MSE ( λ ) = \sqrt{\frac{{\sum }_{i = 1}^{n} {( {x}_{i} - {Z}_{i} )}^{2}}{n}} \qquad [ Mathematical expression 2 ]$$

For example, if variation of the observation value is large, the training engine is controlled to be insensitive to a latest change by decreasing λ, and if the variation of the observation value is small, the training engine is controlled to be sensitive to the latest change by increasing λ.

When λ=0.4[default] is initially set, it is controlled to decrease A value if variance of the observation value during a training reference period is larger than an x value and to increase λ value if the variance is smaller than the x value, and then the variance is measured again. If the measured variance is increased, λ value is decreased, and if the measured variance is decreased, λ value is increased.

Case A: Increase Variance

λ=0.2, {0.4−(0.4−0.0)/2}−>λ=0.1, {0.2−(0.2−0.0)/2}−>λ=0.05, {0.1−(0.1−0.0)/2}

Case B: Decrease Variance

λ=0.7, {0.4+(1.0−0.4)/2}−>λ=0.85, {0.7+(1.0−0.7)/2}−>λ=0.925, {0.85+(1.0−0.85)/2}

At this point, a method of finding an optimum λ minimizes the search time by using Binary Search.

Here, although MSE is recalculated in each iteration until the MSE does not decrease any more, the iteration is limited to five times in maximum to estimate an approximate value considering performance.

The training engine 211 may calculate an Upper Control Limit (UCL) and a Lower Control Limit (LCL) based on the estimated predictive value Z and a standard deviation o of the predictive value.

The Upper Control Limit and the Lower Control Limit are expressed as shown in

UCL=Z+(DetectionLevel·σ₂)

UCL=Z−(DetectionLevel·σ₂) [Mathematical expression 2]

The detection engine 212 may remove false positives from a result of detection using the calculated threshold values and integrate the results. Reliability of a result of detection can be enhanced through such a process of removing false positives.

For example, the present invention detect traffic as anomalous when an observation value goes out of a threshold value calculated through the observation value of traffic measured during a reference period of past four weeks.

Describing specifically, the detection engine 212 may extract network feature data from flowing-in network traffic.

The detection engine 212 may determine existence of anomaly in newly flowing-in normal traffic based on the extracted network feature data and the calculated threshold values, i.e., the Upper Control Limit and the Lower Control Limit. Such a process of determining existence of anomaly is expressed as shown in [Mathematical expression 3].

If(X<LClorX>UCL), Anomaly [Mathematical expression 3]

At this point, the detection engine 212 goes through a process of reducing false positives based on the detected result. That is, the detection engine 212 goes through a false alarm filtering process of removing a result showing a high probability of false positive from a detection result of various feature data.

FIG. 4 is a view for describing a false alarm filtering concept according to an embodiment of the present invention.

As shown in FIG. 4, a false alarm filtering process may reduce false positives from a time series-based detection result through normal training data, based on a frequency of generating abnormal values which are generated at usual times.

As a result of experiments, a correlation-coefficient generated among the false positives in normal traffic is extremely low to be less than 0.05 in average, and thus each event can be regarded as independent. That is, a probability of consecutively generating an abnormal value generated in a normal state is relatively much smaller than an abnormal value generated by an attack. However, the abnormal value generated by an attack is a value intentionally generated by an attacker, and it may be regarded that the probability of having continuity is relatively high.

Accordingly, a frequency of generating abnormal traffic generated during a training period of normal traffic is calculated, and traffic exceeding a range of the frequency generating an abnormal value which can be generated in normal times within a statistical management range is classified as abnormal traffic caused by an attack, and reliability of a result of detection is increased by minimizing the false positives based on the detection.

The detection engine 212 may integrate results of determining existence of anomaly in normal traffic in this manner. Integration of the results of determining existence of anomaly is expressed as shown in [Mathematical expression 4].

AccAnomaly=Σᵢ₌₁^{t}Anomalyᵢ [Mathematical expression 4]

At this point, the detection engine 212 goes through a process of reducing false negatives based on the detected result. That is, a detection result of each feature data removing the false positives is classified by the type as shown in [Table 2], and a different score is assigned according to the type of the detected result, and a reliability grade of the detected result may be classified using an average value of all scores.

TABLE 2

| Code | Description | |
|---|---|---|
| F1 | Abnormal value when traffic is not observed | |
| | during reference period | |
| N_U | Standard deviation is 0 | Abnormal value larger than |
| | during reference period | average during reference period |
| N_D | | Abnormal value smaller than |
| | | average during reference period |

| | |
|---|---|
| A2_U | Abnormal value larger than UCL whose detection |
| | level is 2 |
| A2_D | Abnormal value smaller than LCL whose detection |
| | level is 2 |
| A3_U | Abnormal value larger than UCL whose detection |
| | level is 3 |
| A3_D | Abnormal value smaller than LCL whose detection |
| | level is 3 |

At this point, a grade of threat level is calculated by adding an additional score according to the type of the detected result, and additional scores according to the type of the detected result are as shown in [Table 3].

TABLE 3

| Type | Score |
|---|---|
| F1 | 1.2 |
| N_U | 3 |
| N_D | 3 |
| A2_U | 18 |
| A2_D | 18 |
| A3_U | 6 |
| A3_D | 6 |
| NONE | 0 |

Such a grade of threat level of a detected result is expressed as shown in [Mathematical expression 5].

$$[ Mathematical expression 5 ]$$

$$ThreatLevel = [ ln ( \frac{{\sum }_{i = 1}^{k} {ScoreOfAnomaly}_{i} \times {ω}_{i}^{l}}{k} ) ]$$

A Local Outlier Factor (LOF) is calculated for each detection result with respect to k features, and an average of the scores multiplies by a reliability weighting factor ( ) according thereto is calculated and normalized. In addition, a threat level is graded based on a result quantized by rounding up the normalized score.

At this point, an example of reliability weighting factors according to a LOF result value is as shown in [Table 4].

TABLE 4

| Category | LOF < 1 | 1 ≦ LOF ≦ 2 | LOF > 2 |
|---|---|---|---|
| Weighting factor | 0.7 | 1 | 1.2 |

The reliability level of a result value remaining after filtering the detected result is increased, and a field added to apply the reliability level to a detection result schema is as shown in [Table 5].

TABLE 5

| Category | Description |
|---|---|
| Others | Result of anomaly detected through periodic detection |
| | (Level up by one level) |
| | Result of anomaly detected based on port statistics |
| | (Level up by one level) |
| | Result of anomaly based on long-term analysis |
| | (IP-based detection) (Level up by two levels) |

The detection engine 212 may detect intrusion based on the integrated result.

The normal traffic training method based on clustering conducts pattern training of normal (←qualitative) traffic data by means of similar group clustering of inputted network feature information and detects abnormal traffic which does not belong to a normal cluster by looking for an outlier going out of the normal cluster, which is trained as a result of conducting the pattern training, by a predetermined range.

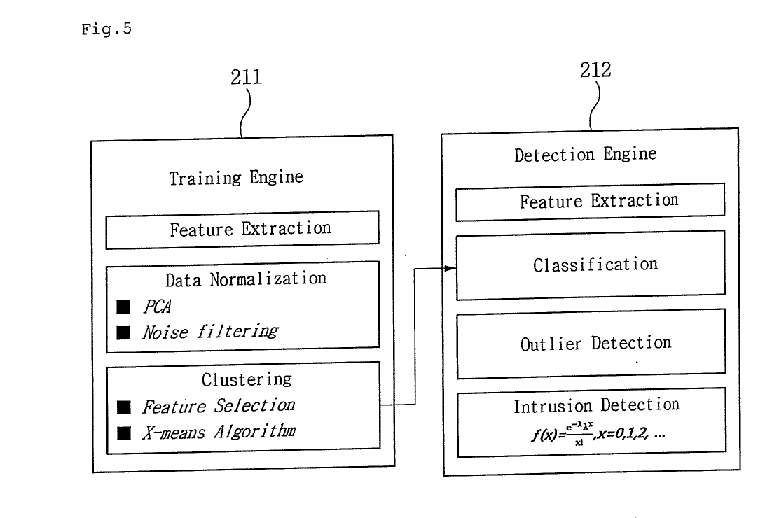

FIG. 5 is a second view for describing an anomaly detecting principle according to an embodiment of the present invention.

Referring to FIG. 5, an anomaly detection engine 210 according to the present invention is configured of a training engine 211 and a detection engine 212 and detects abnormal network traffic.

The training engine 211 may cluster similar groups based on inputted network feature information.

Describing specifically, the training engine 211 may extract network feature data from the data collection device.

The training engine 211 may normalize the extracted network feature data into a training data set and remove noise data which spoils tendency from the training data set.

For example, a value farthest from a centroid value is removed from the training data set one at a time.

The training engine 211 may determine a cluster through a preset clustering algorithm based on the training data set. Here, the clustering algorithm may be an EM algorithm, an X-mean algorithm or the like and can be determined considering convergence speed or performance.

For example, an appropriate number of clusters for clustering is estimated, and a codebook of estimated clusters is created. A distance (Euclidean distance) between each training data set and the centroid of each cluster is calculated, and the Euclidean distance is expressed as shown in [Mathematical expression 6].

EuclideanDistance=\sqrt{Σₖ₌₁ⁿ(pₖ−qₖ)²}, where n is the number of dimensions. [Mathematical expression 6]

A sum of distance between the clusters calculated as described above is calculated, and this is as shown in [Mathematical expression 7].

withinss=(Σₘ|Xₘ−C|²)/p [Mathematical expression 7]

A sum of distance (withiness) is calculated by [Mathematical expression 7], and convergence of a cluster is determined using a result of comparing a value of the calculated sum of distance (withiness).

At this point, the maximum iteration of the cluster convergence is determined between 30 and 100 times according to processing performance.

The detection engine 212 may detect abnormal traffic which does not belong to the trained normal cluster.

Describing specifically, the detection engine 212 may extract network feature data from flowing-in network traffic.

The detection engine 212 may calculate the number of nodes of each cluster within a predetermined distance from the extracted network feature data and select a cluster having the largest number of nodes among the calculated clusters.

The detection engine 212 may calculate a distance (mahalanobis distance) between a value of the centroid of the selected cluster and an input value, and the mahalanobis distance is expressed as shown in [Mathematical expression 8].

$$[ Mathematical expression 8 ]$$

$$Mahalanobis distance = {\sum }_{j , k} = \frac{1}{n - 1} {\sum }_{j = 1}^{n} ( {X}_{ij} - {\overline{X}}_{j} ) ( {X}_{jk} - {\overline{X}}_{k} )$$

The detection engine (212) may determine existence of an outlier based on the calculated distance.

The detection engine 212 may detect abnormal traffic data which does not belong to a normal cluster by looking for an outlier in this method and detect intrusion based on the detected result.

The integrated analysis module 220 may accumulate the detected result at regular intervals, calculate a probability of an abnormal value distribution ratio detected from a detection distribution of normal traffic using the accumulated value, estimate a probability of an attack through the calculated probability, and determine existence of an attack according to the estimated probability of attack.

The result storage DB 230 may store a result of detecting abnormal traffic for each user.

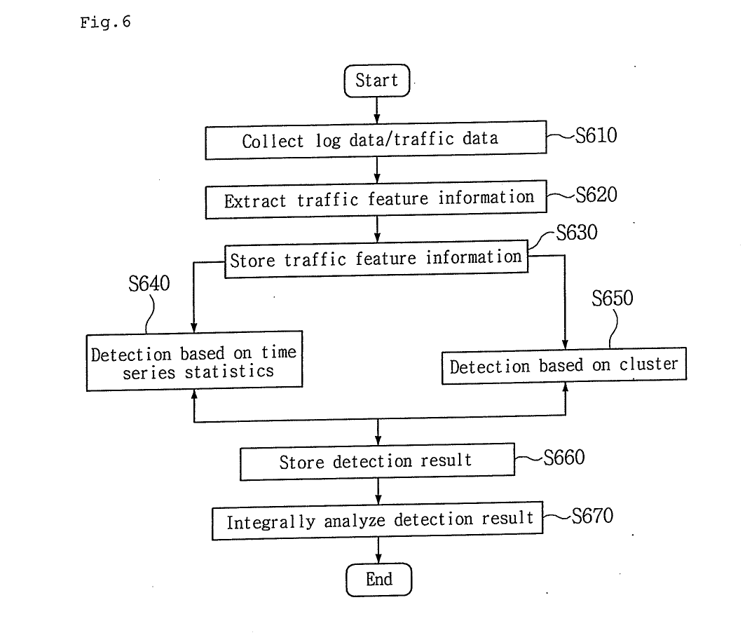

FIG. 6 is a view showing a method of detecting anomalies suspected of an attack according to an embodiment of the present invention.

As shown in FIG. 6, the data collection device according to the present invention may collect log data and traffic data in real-time (S610) and extract traffic feature information from the collected log data and traffic data (S620).

Next, the attack symptom detection device may receive and store the extracted traffic feature information (S630).

Next, the attack symptom detection device may detect abnormal traffic data from newly flowing-in traffic data through a preset detection method based on the stored traffic feature information (S640 and S650).

In the case of a detection method based on time series statistics, the attack symptom detection device calculates a detection threshold value for each user based on the extracted feature value of network time series data of each user IP and detects abnormal network traffic based on the calculated detection threshold value of each user.

In the case of a detection method based on clustering, the attack symptom detection device conducts pattern training of normal traffic data by means of similar group clustering of inputted network feature information and detects abnormal traffic which does not belong to a normal cluster by looking for an outlier going out of the normal cluster, which is trained as a result of conducting the pattern training, by a predetermined range.

Next, the attack symptom detection device may store a result of detecting the abnormal traffic (S660).

Next, the attack symptom detection device may integratingly analyze the results of detecting network anomalies (S670).

That is, the attack symptom detection device may accumulate the detected result at regular intervals, calculate a probability of an abnormal value distribution ratio detected on a detection distribution of normal traffic using the accumulated value, estimate a probability of an attack through the calculated probability, and determine existence of an attack according to the estimates probability of attack.

Meanwhile, the present invention may perform a secondary analysis (profiling) using a result of detecting anomalies.

First, a process of analyzing similarity based on a feature vector is as described below.

1. A vector may be extracted through features of anomaly detection results.

Each feature value is created as a vector.

Standardization considering difference of scale among features: Features of each detection event are converted on the same scale, e.g., the scale is standardized by multiplying a weighting factor (a reciprocal number of a standard deviation) of each feature.

Correction of distance for difference between feature values: When a difference between features caused by a specific outliner value becomes extremely large, the difference between the values are adjusted by rectifying the other values into a square root considering the similarity clustering relatively influenced by the difference of distance.

2. A matrix can be created by calculating a distance between events based on the vector value extracted for each event.

Calculate a distance in a multi-dimensional space for each event.

Clustering after calculating a distance (similarity) between events in a multi-dimensional space: A similarity is calculated using a Euclidean distance between events or calculated using a size and a direction (angle) between events.

Create a distance matrix of n events.

At this point, a square symmetric matrix having a diagonal value of zero is created by calculating a distance between events.

$${Matrix}_{dist} = ( \begin{matrix}{d}_{11} & {d}_{21} & … & {d}_{n 1} \\ {d}_{12} & ⋱ & & ⋮ \\ ⋮ & & ⋱ & ⋮ \\ {d}_{1 n} & … & … & {d}_{nn}\end{matrix} ) \qquad [ Mathematical expression 9 ]$$

3. A multi-dimensional anomaly detection result can be convert into two-dimensional information through a multi-dimensional scaling (MDS) analysis based on the matrix.

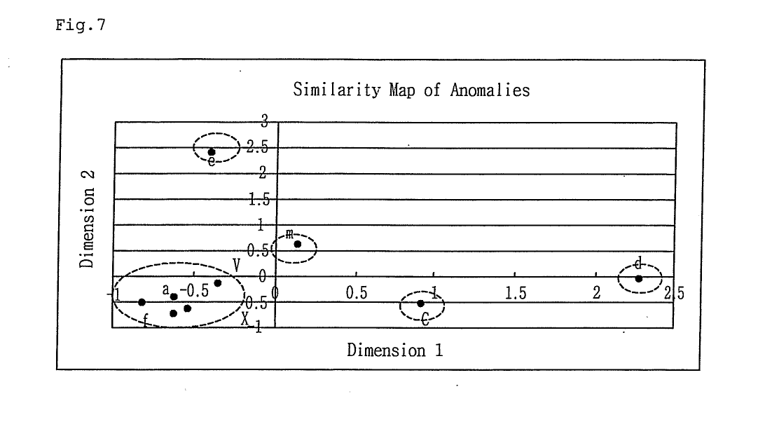

FIG. 7 is a view showing a similarity map of an anomaly detection result according to an embodiment of the present invention.

Referring to FIG. 7, a multi-dimensional anomaly detection result is converted into two-dimensional information through a multi-dimensional scaling (MDS) technique, and information which can be expressed in visualizing the converted information is extracted.

A process of analyzing similarity based on a binary feature vector is as described below.

1. A binary feature vector can be extracted through features of anomaly detection results.

Extract values of a binary feature vector in which all the features have a value of 0 (normal) or 1 (abnormal).

2. A matrix can be created by calculating a distance between events based on the extracted vector values of each event.

Calculate a distance and similarity between events based on the extracted binary feature vector values of each event: Calculate a Hamming distance (similarity) between the extracted binary vector values of each event or calculate a cosine-based distance (similarity) through k feature values.

Create a distance matrix of n events.

At this point, a square symmetric matrix having a diagonal value of zero is created by calculating a distance between events.

3. A multi-dimensional anomaly detection result can be convert into two-dimensional information through multi-dimensional scaling (MDS) analysis based on the matrix.

Meanwhile, although it is described that all the constitutional components configuring the embodiments of the present invention described above are combined into one piece or operate in combination, it does not mean that the present invention is necessarily limited to these embodiments. That is, within the scope of the present invention, one or more of the constitutional components may be selectively combined and operate. In addition, although each of the constitutional components may be implemented as single independent hardware, some or all of the constitutional components may be selectively combined and implemented as a computer program having a program module which performs some or all of combined functions in one or a plurality of pieces of hardware. In addition, the embodiments of the present invention can be implemented by storing such a computer program in a computer readable medium such as USB memory, a CD disk, flash memory or the like and reading and executing the computer program in a computer. The storage medium of the computer program may include a magnetic recording medium, an optical recording medium, a carrier wave medium and the like.

Through this, the present invention has an effect of efficiently detecting abnormal network traffic by extracting traffic feature information from network traffic, training through a time series analysis-based normal traffic training model using the extracted traffic feature information, and detecting the abnormal network traffic suspected of an attack based on a detection threshold value of each user calculated as a result of the training.

In addition, the present invention has an effect of improving reliability on detection results by minimizing false positives by removing a result showing a high probability of false positive from the detection results and minimizing false negatives by enhancing a detection rate by integrating the detection results.

In addition, it is effective in that the present invention can be utilized in security equipment for detecting intrusion from outside, such as Intrusion Detection System (IDS), Intrusion Prevention System (IPS) or the like.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of detecting anomalies suspected of an attack, the method comprising the steps of:
collecting log data and traffic data in real-time and extracting at least one piece of preset traffic feature information from the collected log data and traffic data; and
training through a time series analysis-based normal traffic training model using the extracted traffic feature information, and detecting abnormal network traffic according to a result of the training.

2. The method according to claim 1, wherein when the time series analysis-based normal traffic training model is used, the detecting step includes:
calculating a detection threshold value of each user based on the extracted feature value of network time series data of each user IP; and
detecting the abnormal network traffic based on the calculated detection threshold value of each user.

3. The method according to claim 2, wherein the detecting step includes:
extracting an average value and a variance value of the network feature data by a time unit;
performing a time series analysis on a past observation value based on the extracted average value of each time unit and estimating a predictive value to be observed in the future based on a result of performing the time series analysis; and
calculating threshold values of an upper control limit and a lower control limit based on the estimated predictive value and a standard deviation of the predictive value.

4. The method according to claim 3, wherein the detecting step includes obtaining the predictive value using mathematical expression Zₜ=λxₜ+(1−λ)Zₜ₋₁, 0<λ<1 , and here, λ denotes a weighing factor of the predictive value, and x denotes feature information (observation value) extracted in each time zone.

5. The method according to claim 4, wherein the detecting step includes obtaining λ using mathematical expression
$$MSE ( λ ) = \sqrt{\frac{{\sum }_{i = 1}^{n} {( {x}_{i} - {Z}_{i} )}^{2}}{n}} ,$$
and here, λ is adjusted to be determined as a value which can minimize a mean square error (MSE) during a training period.

6. The method according to claim 2, wherein the detecting step includes:
determining existence of anomaly in flowing-in normal traffic based on the extracted network feature data and the calculated threshold values; and
integrating results of determining existence of anomaly in the normal traffic and detecting intrusion according to a result of the integration.

7. The method according to claim 6, wherein the detecting step includes determining existence of anomaly in the normal traffic using mathematical expression “If(X<LCL or X>UCL), Anomaly”, and here, the LCL denotes a threshold value of a lower control limit, and the UCL denotes a threshold value of an upper control limit.

8. The method according to claim 6, wherein the detecting step includes:
assigning a different score according to a preset type of the integrated result, and
classifying a grade of threat level of the detection result using an average value of all the scores, wherein
the grade of threat level is calculated using mathematical expression
$$ThreatLevel = [ ln ( \frac{{\sum }_{i = 1}^{k} {ScoreOfAnomaly}_{i} \times {}_{i}^{l} ω}{k} ) ] .$$

9. The method according to claim 1, wherein the traffic feature information includes at least one of the number of packets per flow, an amount of data per flow, a flow duration time, an average number of packets per unit time, an average amount of data per unit time, and an average amount of data per packet.

10. A method of detecting anomalies suspected of an attack, the method comprising the steps of:
receiving traffic feature information extracted from log data and traffic data from a data collection device and storing the received traffic feature information; and
training through a time series analysis-based normal traffic training model using the stored traffic feature information, and detecting abnormal network traffic according to a result of the training.

11. The method according to claim 10, wherein when the time series analysis-based normal traffic training model is used, the detecting step includes:
calculating a detection threshold value of each user based on the extracted feature value of network time series data of each user IP; and
detecting the abnormal network traffic based on the calculated detection threshold value of each user.

12. The method according to claim 11, wherein the detecting step includes:
extracting an average value and a variance value of the network feature data by a time unit;
performing a time series analysis on a past observation value based on the extracted average value of each time unit and estimating a predictive value to be observed in the future based on a result of performing the time series analysis; and
calculating threshold values of an upper control limit and a lower control limit based on the estimated predictive value and a standard deviation of the predictive value.

13. The method according to claim 11, wherein the detecting step includes:
determining existence of anomaly in flowing-in normal traffic based on the extracted network feature data and the calculated threshold values; and
integrating results of determining existence of anomaly in the normal traffic and detecting intrusion according to a result of the integration.
